(19) United States
(12) Patent Application Publication
(10) Pub. No.: US 2006/0279268 A1
(43) Pub. Date: Dec. 14, 2006

(54) Method for Operational Amplifier Output Clamping for Switching Regulators

(75) Inventor: Tim Wen Hui Yu, 830 E. Arques Avenue, CA (US)

Correspondence Address: ADVANCED ANALOGIC TECHNOLOGIES, 830 EAST ARQUES AVE, SUNNYVALE, CA, 94085, US

(73) Assignee: Advanced Analogic Technologies, Inc., Sunnyvale, CA (US)

(21) Appl. No.: 11/160,161

(22) Filed: Jun. 10, 2005

(51) Int. Cl. G05F 1/00

(52) U.S. Cl. 323/282

(57) ABSTRACT

A switching regulator includes a feedback network that generates a voltage Vₑₐ that is proportional to the difference between the output of the switching regulator and a reference voltage. A comparator is used to compare Vₑₐ to a sawtooth voltage to generate a voltage V_{pwm}. The voltage V_{pwm} drives a high-side switching transistor that controls the output of the regulator. A first clamping transistor that provides a variable gain connection between the voltage Vₑₐ and ground. As Vₑₐ rises above a predefined level, the clamping circuit increases the connection between Vₑₐ and ground, preventing Vₑₐ from substantially exceeding Vₜ. As a result, transient performance of the regulator is improved.

### BACKGROUND OF THE INVENTION

Switching regulators or switching power supplies are commonly used as sources of regulated power for electronic circuits of all types. FIG. 1A shows a typical implementation of a voltage reducing, or buck regulator. As shown in FIG. 1A, the buck regulator includes an inductor connected in series with a parallel combination of a capacitor and a load (the load is represented in the figure by a resistor). A switching transistor M1 is connected between the inductor and a power source. A diode is connected between the inductor and ground. A controller (not shown) enables and disables the switching transistor to create two operational phases. During the first phase, known as the charging phase, the transistor is enabled and current flows from the power source through the inductor. This causes energy to be stored by the inductor in the form of a magnetic field. During the second phase, known as the discharge phase, the transistor is disabled. With the transistor disabled, the diode provides a connection between the inductor and ground. Current continues to flow from the inductor through the load as the magnetic field collapses. The transistor is repeatedly enabled and disabled to create a train of charge and discharge phases, powering the load with a series of pulses. As mentioned, the buck regulator of FIG. 1A is voltage reducing. By rearranging its components, the voltage increasing, or boost regulator of FIG. 1B or the voltage inverting or buck-boost regulator of FIG. 1C can be produced.

Switching power supplies are generally adaptive—they change their outputs in response to load changes. This is typically accomplished using two different techniques: 1) pulse-width-modulation (PWM) and 2) pulse-frequency-modulation (PFM). For PWM operation, the switching transistor is switched on and off at a fixed rate regardless of load. The duty cycle of the transistor is variable and increases or decreases in proportion to the load applied. PFM operation is the exact opposite—duty cycle is fixed and the rate at which the transistor is switched on and off is changed in proportion to the load applied. Of the two, PWM designs dominate in portable applications. This is largely because PFM regulators operate over a range of frequencies, creating a spectrum of electromagnetic noise that may be difficult to effectively control. Switching power supplies can also be constructed to use both PWM and PFM at different times, depending on load or other factors.

Where regulator efficiency is important, it is common to replace the diode of FIG. 1A through 1C with a second transistor. In these cases, the transistor that connects the inductor to power is referred to as the high-side transistor and the transistor that connects the inductor to ground is referred to as the low-side transistor. The two transistor designs are commonly referred to as synchronous rectifiers because of the synchronous operation of the high and low-side transistors. FIG. 2 shows a buck regulator implemented as a synchronous rectifier.

Switching regulators generally use some sort of feedback loop to monitor their output and dynamically adjust pulse width (for PWM) or pulse frequency (for PFM). A typical feedback circuit for PWM regulators is shown in FIG. 3. For that circuit an error amplifier X1 monitors a feedback voltage V_{fb} and a reference voltage V_{ref}. The feedback voltage V_{fb} is derived from the output voltage (in this case by a voltage splitting arrangement). The reference voltage V_{ref} is typically generated externally and represents the target output of the switching regulator. The output of the error amplifier Vₑₐ reflects the difference between the output of the regulator and the desired output.

The error amplifier Output Vₑₐ is passed to a comparator X2. The second input to the comparator X2 is a sawtooth voltage Vₜ. In this case, the sawtooth voltage Vₜ is derived using a transistor M3 and a current source to level shift the inductor input voltage. The sawtooth voltage Vₜ may also be produced using a range of other methods or may be externally supplied. The output of the comparator X2 is a square wave voltage V_{pwm} that controls the high-side transistor. As shown in FIGS. 4A and 4B, the duty cycle of the square wave V_{pwm} is controlled by Vₑₐ. As Vₑₐ decreases, the duty cycle of V_{pwm} increases. This inverse relationship means that the duty cycle of V_{pwm} and the duty cycle of the high-side transistor increases as the load on the switching regulator increases.

In most cases, the feedback circuit of FIG. 3 is an effective mechanism for controlling regulator output. Problems may arise, however because the error amplifier output Vₑₐ has a much greater range than the range of the sawtooth voltage Vₜ. In cases where Vₑₐ exceeds this range, comparator X2 may enter open loop operation.

### SUMMARY OF THE INVENTION

The present invention includes an operational amplifier output clamping method. For a typical implementation, the clamping method is used as part of a feedback network that controls a buck, boost or buck-boost switching regulator. The feedback network uses a voltage divider or other mechanism to generate a voltage V_{fb} that is proportional to the output of the switching regulator. An error amplifier compares V_{fb} to a desired voltage V_{ref} and generates a corresponding voltage Vₑₐ. Vₑₐ, along with a sawtooth voltage Vₜ is passed to a comparator. The comparator generates a square wave voltage V_{pwm} having a duty cycle that is determined by the magnitude of Vₑₐ relative to the sawtooth voltage Vₜ.

The switching regulator may include one or two switching transistors. In the case where two transistors are included (a high-side and a low-side) V_{pwm} may be used to drive one or both transistors. In the case where only one transistor is included, V_{pwm} is used to drive that transistor. Vₜ may be generated externally or may be derived by monitoring the current flowing through the high-side switching transistor.

One or two clamping circuits is used to maintain the voltage Vₑₐ within a range where it is relatively close to the range of Vₜ. Each clamping circuit uses an op amp and a clamping transistor. In the first clamping circuit, the clamping transistor controls a connection between Vₑₐ and ground. In the second clamping circuit, the clamping transistor controls a connection between Vₑₐ and the input voltage to the switching regulator. The op amps in both circuits monitor Vₑₐ. As Vₑₐ rises above a predefined level, the op amp in the first clamping circuit increases the drive to its transistor, increasing the connection between Vₑₐ and ground. As a result, Vₑₐ is prevented from substantially exceeding Vₜ. As Vₑₐ falls below another predefined level, the op amp in the second clamping circuit increases the drive to its transistor, increasing the connection between Vₑₐ and the input voltage to the switching regulator. As a result, Vₑₐ is prevented from falling substantially below Vₜ.

By maintaining Vₑₐ within a range that is close to the range of Vₜ, the comparator that produces V_{pwm} is prevented from entering open loop operation and the transient response of the switching regulator is improved.

### BRIEF DESCRIPTION OF THE DRAWINGS

FIG. 1A is a block diagram of a prior art buck regulator.

FIG. 1B is a block diagram of a prior art boost regulator.

FIG. 1C is a block diagram of a prior art buck-boost regulator.

FIG. 2 is a block diagram of a prior art buck-type synchronous switching regulator.

FIG. 3 shows a feedback arrangement for the prior art buck-type synchronous switching regulator of FIG. 2.

FIGS. 4A and 4B show the voltage waveforms associated with the feedback arrangement of FIG. 3.

FIG. 5 is a block diagram of a buck-type synchronous switching regulator using a first implementation of a clamping circuit provided by the present invention.

FIG. 6 is a block diagram of a buck-type synchronous switching regulator using a second implementation of a clamping circuit provided by the present invention.

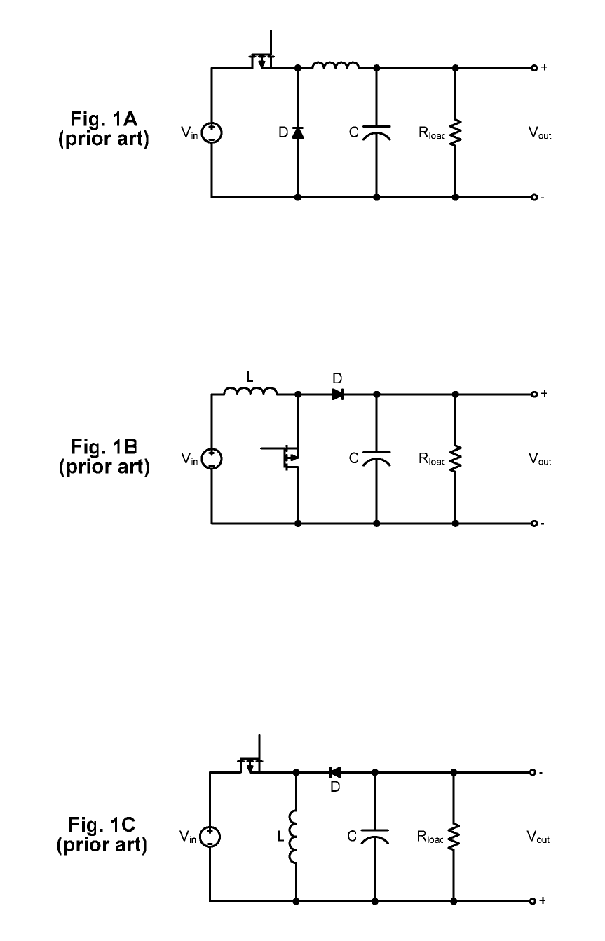

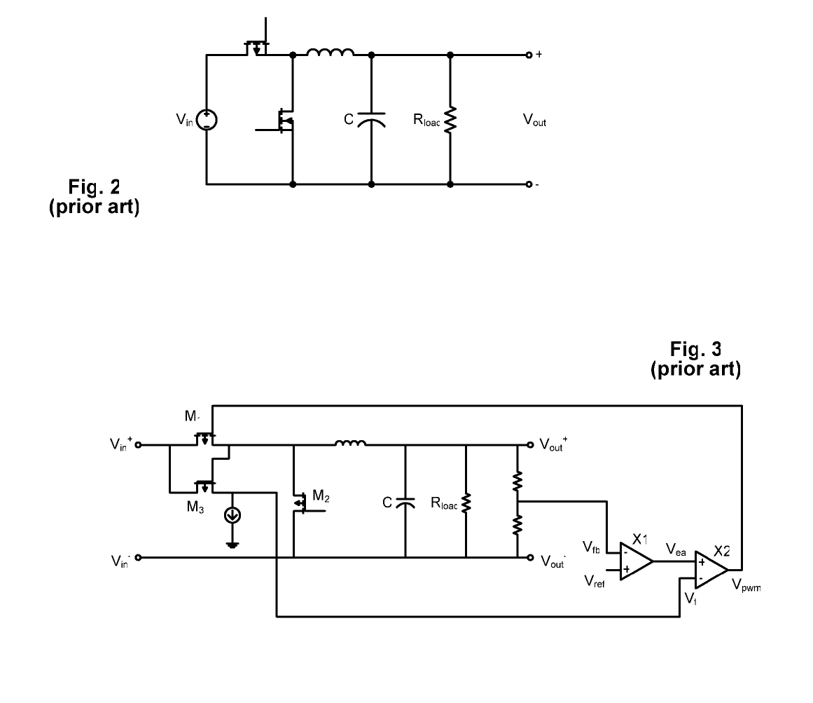

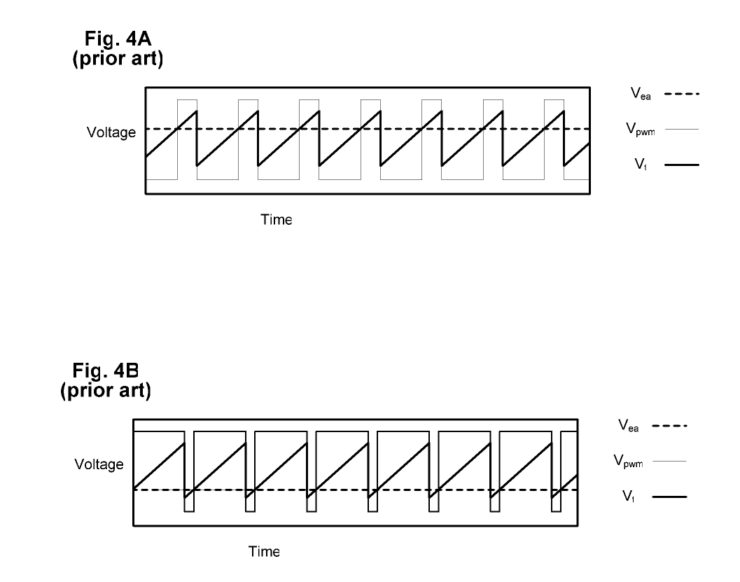

### DETAILED DESCRIPTION OF THE PREFERRED EMBODIMENTS

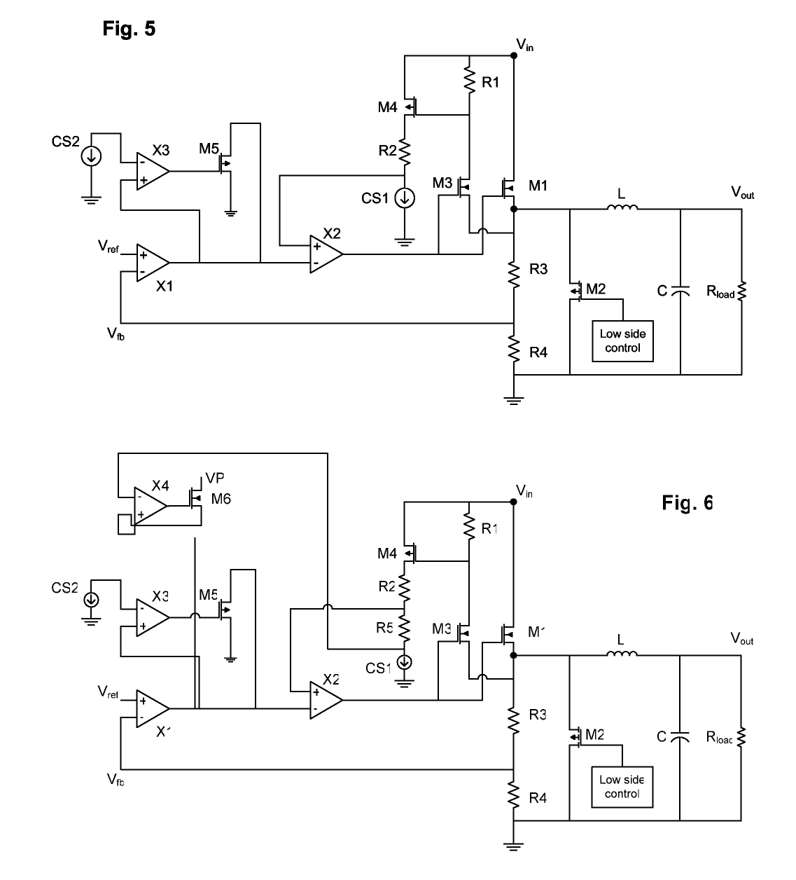

The present invention includes an operational amplifier output clamping method for use with buck, boost and buck-boost switching regulators. As an example, FIG. 5 shows a buck regulator 500 implemented using this method. Buck regulator 500 includes a high-side switch M1, a low-side switch M2, an inductor L, a capacitor C and a load (represented in this figure by a resistor Rload) all arranged in a topology typical for buck regulators. In cases where the clamping method is used for boost or buck-boost regulators, these same components would typically be included but would be arranged in topologies appropriate for regulators of those types.

The low-side switch M2 provides a connection between the inductor L and ground. A low-side control circuit controls operation of the low-side switch M2. This circuit can be implemented to operate using a range of different algorithms. For the purposes of this description, it may be assumed that the low side control circuit senses the polarity over the low-side switch M2 and causes the low-side switch M2 to act as a lossless diode (i.e., a diode having a forward voltage of zero volts).

The high-side switch M1 provides a connection between the input voltage to the buck regulator 500 and the inductor L. The high-side switch M1 is controlled by the output of PWM comparator X2. Comparator X2 has two inputs. The first input is a sawtooth voltage Vₜ. In this case, the sawtooth voltage Vₜ reflects the current flowing through the high-side transistor M1. Vₜ is generated using transistor M3 and resistor R1 to measure the current flowing through the high-side transistor M1. The resulting value is then level shifted using the combination of the transistor M4, resistor R2 and current source CS1 to form the sawtooth voltage Vₜ.

The second input to the comparator X2 is the output Vₑₐ of an error amplifier X1. The error amplifier X1 monitors a feedback voltage V_{fb} and a reference voltage V_{ref}. The feedback voltage V_{fb} is derived from the output voltage (in this case using resistors R3 and R4 as a voltage divider). The reference voltage V_{ref} is typically generated externally and represents the target output of the switching regulator. The output of the error amplifier Vₑₐ reflects the difference between the output of the regulator and the desired output.

A clamping circuit formed by op amp X3, current source CS2 and transistor M5 is used to stabilize the voltage Vₑₐ. As Vₑₐ increases the output of op amp X3 also increases, increasing the gain to transistor M5. The increased gain on transistor M5 pulls Vₑₐ towards ground, preventing Vₑₐ from exceeding the voltage established by current source CS2. As a result, Vₑₐ remains much closer to sawtooth voltage Vₜ preventing comparator X1 from entering open loop operation and improving the transient response of buck regulator 500.

FIG. 6 shows a second implementation of buck regulator 500. This second implementation includes all of the elements shown in FIG. 5. In addition, a second clamping circuit is formed by op amp X4 and transistor M6. As Vₑₐ decreases, the inputs to op amp X4 become increasingly equal. As a result, the output of op amp X4 decreases and the transistor M6 becomes increasingly enabled. As a result, Vₑₐ is boosted preventing it from falling significantly below sawtooth voltage Vₜ.

The implementations shown in FIGS. 5 and 6 provide two different types of clamping. The first (shown in FIG. 5) prevents Vₑₐ from substantially exceeding Vₜ. The second (shown in FIG. 6) prevents Vₑₐ from falling substantially below Vₜ. Either or both types of clamping may be used, depending on the desired end use. As mentioned previously, the clamping method is intended to be used with buck, boost and buck-boost type switching regulators.

What is claimed is:

1. A method for controlling a switching regulator that includes a high-side switching transistor, the method comprising:
generating a voltage Vₑₐ that is proportional to the difference between the output of the switching regulator and a reference voltage;
generating a sawtooth voltage Vₜ that is proportional to the current passing through the high-side switching transistor;
modulating a variable gain connection between the voltage Vₑₐ and ground as a function of Vₑₐ to limit the degree to which Vₑₐ is allowed to exceed Vₜ; and
comparing Vₑₐ and Vₜ to generate a PWM signal to drive the high-side switching transistor.

2. A method as recited in claim 1 that further comprises: modulating a variable gain connection between the voltage Vₑₐ and the input voltage to the switching regulator as a function of Vₑₐ to limit the degree to which Vₑₐ is allowed to fall below Vₜ.

3. A method as recited in claim 1 in which the step or modulating a variable gain connection between the voltage Vₑₐ and ground further comprises:
generating a voltage proportional to the difference between Vₑₐ and a voltage generated by a current source; and
using the proportional voltage to control a transistor that connects Vₑₐ to ground.

4. A method as recited in claim 2 in which the step or modulating a variable gain connection between the voltage Vₑₐ and the input voltage to the switching regulator further comprises:
generating a voltage proportional to the difference between Vₑₐ and a voltage generated by a current source; and
using the proportional voltage to control a transistor that connects Vₑₐ to the input voltage to the switching regulator.

5. A circuit for controlling a switching regulator that includes a high-side switching transistor, the circuit comprising:
a first op amp that generates a voltage Vₑₐ that is proportional to the difference between the output of the switching regulator and a reference voltage;
a current sensing circuit that that generates a sawtooth voltage Vₜ that is proportional to the current passing through the high-side switching transistor;
a first clamping transistor that provides a variable gain connection between the voltage Vₑₐ and ground;
a second op amp that drives the first clamping transistor as a function of Vₑₐ to limit the degree to which Vₑₐ is allowed to exceed Vₜ; and
a third op amp that compares Vₑₐ and Vₜ to generate a voltage V_{pwm} to drive the high-side switching transistor.

6. A circuit as recited in claim 5 that further comprises:
a second clamping transistor that provides a variable gain connection between the voltage Vₑₐ and the input voltage to the switching regulator; and
a fourth op amp that drives the second clamping transistor as a function of Vₑₐ to limit the degree to which Vₑₐ is allowed to fall below Vₜ.

7. A switching regulator that comprises:
a high-side switching transistor;
a feedback network that generates a voltage Vₑₐ that is proportional to the difference between the output of the switching regulator and a reference voltage;
a comparator that compares Vₑₐ to a sawtooth voltage to generate a voltage V_{pwm} to drive the high-side switching transistor;
a first clamping transistor that provides a variable gain connection between the voltage Vₑₐ and ground; and
a first op amp that drives the first clamping transistor as a function of Vₑₐ to limit the degree to which Vₑₐ is allowed to exceed Vₜ.

8. A switching regulator as recited in claim 7 that further comprises:
a second clamping transistor that provides a variable gain connection between the voltage Vₑₐ and the input voltage to the switching regulator; and
a second op amp that drives the second clamping transistor as a function of Vₑₐ to limit the degree to which Vₑₐ is allowed to fall below Vₜ.
